(19) United States
(12) Patent Application Publication
(10) Pub. No.: US 2015/0179346 A1
(43) Pub. Date: Jun. 25, 2015

(54) METHOD OF CURVING A DYE SENSITIZED SOLAR CELL FOR VEHICLE

(71) Applicant: HYUNDAI MOTOR COMPANY, Seoul (KR)

(72) Inventors: Eun Young Lee, Seoul (KR); Hae Yoon Jung, Seoul (KR); Sang Hak Kim, Seoul (KR); Mi Yeon Song, Seoul (KR); Sung Geun Park, Seoul (KR)

(21) Appl. No.: 14/562,675

(22) Filed: Dec. 6, 2014

(30) Foreign Application Priority Data
Dec. 19, 2013 (KR) 10-2013-0159029

(51) Int. Cl. H01G 9/00; H01G 9/20

(52) U.S. Cl. CPC H01G 9/0036; H01G 9/2068

(57) ABSTRACT

Disclosed is a method of manufacturing a curved a solar cell module which is closely contacting a curve roof panel of a vehicle without incurring separation when the solar cell module is attached to the curved roof panel for a vehicle. Accordingly, stress applied to the curved solar cell module by the curved surface may be minimized by fabricating a curved solar cell module having the same curvature as the roof panel to provide a close-contact problem between the roof panel and the solar cell module.

### CROSS-REFERENCE TO RELATED APPLICATION

This application claims under 35 U.S.C. §119(a) the benefit of Korean Patent Application No. 10-2013-0159029 filed on Dec. 19, 2013, the entire contents of which are incorporated herein by reference.

### TECHNICAL FIELD

The present invention relates to a method of manufacturing a curved solar cell module having the same curvature as a vehicle roof panel.

### BACKGROUND

Recently, as an environment-friendly energy field has been highlighted, photoelectric conversion elements, such as a solar cell, have been widely used.

Among them, a silicon solar cell has been commercially used and already applied to a sun roof part of a vehicle, but the silicon solar cell may be limited in use due to an opaque property and high cost.

Accordingly, a dye sensitized solar cell used as a semi-transparent and transparent solar cell has been recently developed for a commercial use, such that research for application of the solar cell to various application fields such as vehicle and building integrated photovoltaic (BIPV) has been actively conducted.

In general, the dye sensitized solar cell refers to a cell having a structure where a working electrode and a counter electrode are bonded on a transparent conductive substrate, and an 1/I₃-based electrolyte is filled between the working electrode and the counter electrode. The working electrode is typically coated with a semiconductor oxide thick film such as TiO₂ onto which a Ru-based dye capable of absorbing light is adsorbed, and the counter electrode is coated with a catalyst electrode using Pt.

Since the dye sensitized solar cell has low manufacturing cost, is available for manufacturing a transparent conductive substrate, and is available for manufacturing solar cells having various designs, substantial research on the dye sensitized solar cell has been continuously performed and the dye sensitized solar cell has been substantially applied to various fields. In particular, the dye sensitized solar cell has been introduced substantially to a roof or a window of a building for the BIPV. In addition, the dye sensitized solar cell has been currently applied to a roof of a vehicle instead of the silicon solar cell.

The dye sensitized solar cell is mostly applied in the form of a plane module, and the application of a flexible dye sensitized solar cell to a curved point of a bag or a cloth has not been frequently attempted. Indeed, the plane module may not be applied to a curved structure of a vehicle due to a design of the curved structure.

Although various designs have been gradually applied to the vehicle by mounting a plane substrate or the flexible dye sensitized solar cell, a design may be degraded.

Accordingly, development of a curved structure or design of the dye sensitized solar cell is demanded to apply the dye sensitized solar cell to such as a vehicle, without losing performance of photovoltaic conversion of solar energy.

When a roof panel of a vehicle is connected with a solar cell module manufactured on a substrate which does not have the same curvature or has a plane surface as shown in \textcircled{a} of FIG. 1, the roof and the solar cell may not contact closely to each other, such that separation may incur, thereby degrading mechanical stability and an aesthetic appearance. Otherwise, electrical resistance generated when bonded parts between modules are not in close contact with each other may be generated due to a curvature difference as shown \textcircled{b} of FIG. 1.

In the related art for a modified solar cell panel, a configuration that a stacked solar cell module is heated and compressed between two metal plates in a heated state in the range of about 80° C. to 200° C. and a vacuum state, and then compressed between two curved dyes has been provided.

In the related arts, a molding method of mounting a pair of conductive film glass plates on a curved form has also been provided such that outer peripheral portions of the pair of conductive film glass plates may be supported by an outer peripheral portion of the curved form. The method may further include heating and bending the pair of conductive film glass plates into a desired shape.

In addition, a method of manufacturing a glass for a vehicle material has been developed. The method indicates that first and second glass substrates may be simultaneously bent so as to have a predetermined 3D curved shape when the first and second glass substrates are polymerized.

Moreover, a method of manufacturing a solar cell module for a sun roof of a vehicle has been introduced and in the method, a laminating operation for bonding a curved glass of a sun roof and a solar cell may be performed through a floor plate of a laminator device manufactured such that the floor plate may have the same curvature as the curved glass of the sun roof. However, the aforementioned technologies may not be suitable to a roof of a vehicle having various curvatures.

The above information disclosed in this Background section is only for enhancement of understanding of the background of the invention and therefore it may contain information that does not form the prior art that is already known in this country to a person of ordinary skill in the art.

### SUMMARY OF THE INVENTION

In a preferred aspect, the present invention can address one or more of the above-described technical difficulties in close-contact between the roof panel and the solar cell module. In particular, the present invention provides a method of manufacturing a curved solar cell module which may closely contact a curved roof panel of a vehicle without incurring separation when the solar cell module is attached to the curved roof panel. Accordingly, stress applied to the module may be minimized by manufacturing the curved solar cell module having the same curvature as the roof panel.

In one aspect, the method of manufacturing a curved dye sensitized solar cell for a vehicle may include steps of: (i) forming a first substrate by fabricating a transparent conductive layer on a plane thin film glass substrate and then forming a photoelectrode or a counter electrode of the dye sensitized solar cell; (ii) bending the first substrate where the photoelectrode or the counter electrode are formed, such that the first substrate has the same curvature as a roof panel of the vehicle by using a first curved zig (zig 1); (iii) applying an outer bonding agent on the curved first substrate; (iv) bending a second substrate such that the second substrate has the same curvature as the first substrate by using a second curved zig (zig 2); and (v) providing the second substrate on the first substrate and hardening the outer bonding agent between the substrates in the curved state.

The curved module manufactured by the method of the present invention may have advantages compared to the related art. For example, as shown in FIG. 1, degradation of mechanical stability and an aesthetic appearance due to failure of close contact between a roof and a solar cell and generation of separation when the roof panel is connected with the solar cell module manufactured on a plane substrate may be eliminated. In addition, electrical resistance generated when bonded parts between modules are not in close contact with each other due to a curvature difference may be reduced, and thus performance of the solar cell panel may be improved. Moreover, stress applied to the module by curving the module before the bonding may be minimized and different curved glass substrates may be manufactured according to different curvature of the roof panel in the vehicle for each position. Further, the curved module may be manufactured by using conventional electrode printing process equipment and forming an electrode on a plane substrate.

Further provided are vehicle roof panels comprise a dye sensitized solar cell obtained or obtainable from a method as disclosed herein. Also provided are vehicles including automotive vehicles that comprise a vehicle roof panel that comprises a dye sensitized solzr cell as disclosed herein.

Other aspects and preferred embodiments of the invention are discussed infra.

### BRIEF DESCRIPTION OF THE DRAWINGS

The above and other features of the present invention will now be described in detail with reference to various exemplary embodiments thereof illustrated in the accompanying drawings which are given hereinbelow by way of illustration only, and thus are not limitative of the present invention, and wherein:

FIG. 1 illustrates a bonded state of a panel of a general plane module in the related arts;

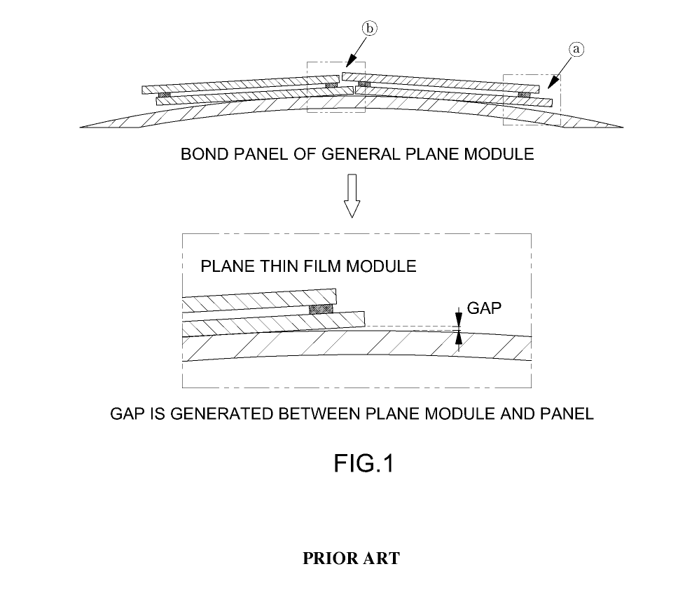

FIG. 2 illustrates an exemplary method of manufacturing an exemplary curved solar cell module according to an exemplary embodiment of the present invention;

FIG. 3 illustrates an exemplary process where an exemplary curved solar cell module is bonded with a curved roof panel according to an exemplary embodiment of the present invention; and

FIG. 4 illustrates an exemplary method using an exemplary substrate incurvating apparatus.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

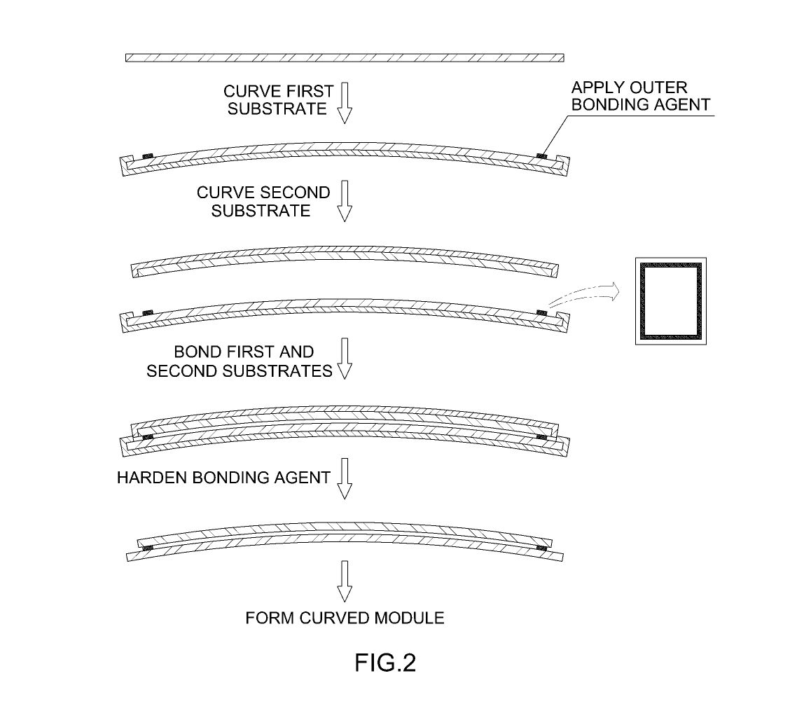

The present invention provides a method of curving a dye sensitized solar cell for a vehicle. The method may include steps of: (i) fabricating a first substrate by forming a transparent conductive layer on a plane thin film glass substrate and then forming a photoelectrode or a counter electrode of the dye sensitized solar cell; (ii) bending the first substrate where the photoelectrode or the counter electrode is formed, such that the first substrate has the same curvature as a roof panel of a vehicle by using a first curved zig (zig 1); (iii) applying an outer bonding agent on the curved first substrate; (iv) bending a second substrate such that the second substrate has the same curvature as the first substrate by using a second curved zig (zig 2); and (v) putting the second substrate on the first substrate and hardening the outer bonding agent between the substrates in the curved state (FIG. 2). In particular, each process may be performed under a processing condition where the curved form of each substrate may maintain after the curved zigs are removed.

Alternatively, steps of (iii) and (iv) may be performed in reversed order. Meanwhile, one or more spacers may be coated on an edge portion of the zig, and one or more apertures for injecting an electrolyte may be processed in the first substrate mounted on the first zig. The spacer may be shaped like a pin such that the spacer may be disposed in the aperture for injecting the electrolyte. Alternatively, the spacers may be U shaped having one open end.

The first substrate and the second substrate may be coaxially or biaxially bent, the number of curvatures may be applied at two or more positions, and a radius of the curvature may be from about 2 to about 9 m.

The first zig or the second zig may vacuum adsorb and support the substrate, and the edge of the zig may have a ring-shaped structure holding the substrate such that the substrate may be prevented from being plane. The spacers made of an elastic material, such as silicon, rubber, or resin, may be coated on the edge of the zig.

The pin-shaped spacers passing through the apertures for injecting the electrolyte of the first substrate may be disposed in the first zig, and a diameter of the pin-shaped spacer may be of about 2 mm or less. A material of the pin-shaped spacer may be selected from the group consisting of silicon, rubber, resin, and Teflon.

The outer bonding agent may be, but not limited to, a photocurable or thermosetting epoxy or silicon adhesive.

A magnitude of stress applied by the curved surface of the curved dye sensitized solar cell module may be of about the stress of one sheet of the thin film glass substrate.

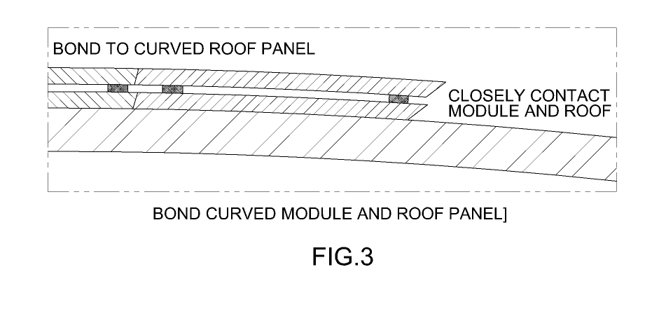

FIG. 3 illustrates an exemplary curved module which is bonded with a curved roof panel according to an exemplary embodiment.

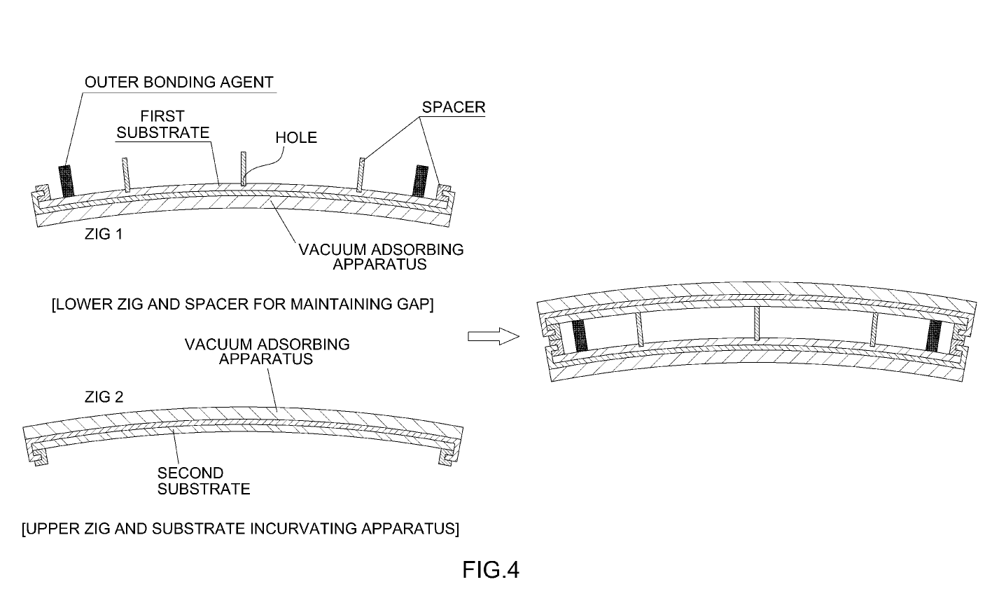

In FIG. 4, a vacuum adsorbing apparatus may be included in each of the upper and lower zigs, such that the substrate may be curved while being adsorbed onto the zigs.

The edge portion of the zig may have a shape to hold the substrate such that the substrate may be prevented from being plane, and may be coated with one or more spacers made of an elastic material, and the like, thereby serving to maintain an interval between the upper and lower substrates and preventing the substrates from being damaged. The apertures for injecting the electrolyte may be processed in the first substrate mounted on the first zig or the lower zig (zig 1). Accordingly, the pin-shaped spacers passing through the apertures may uniformly maintain the intervals between the first and the second substrates, or alternatively, between the upper and lower substrates.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method of curving a dye sensitized solar cell for a vehicle, comprising:
(i) fabricating a first substrate by forming a transparent conductive layer on a plane thin film glass substrate and then forming a photoelectrode or a counter electrode of the dye sensitized solar cell;
(ii) bending the first substrate, on which the photoelectrode or the counter electrode is formed, to form the first substrate with the same curvature as a roof panel of the vehicle by using a first curved zig;
(iii) applying an outer bonding agent on the curved first substrate;
(iv) bending a second substrate to form the second substrate with the same curvature as the first substrate by using a second curved zig; and
(v) disposing the second substrate on the first substrate and hardening the outer bonding agent between the first and second substrates having the same curvature.

2. The method of claim 1, wherein the step of (iv) is performed prior to the step of (iii).

3. The method of claim 1, wherein one or more spacers are coated on an edge portion of the zig.

4. The method of claim 1, wherein one or more apertures for injecting an electrolyte are processed in the first substrate mounted on the first zig.

5. The method of claim 4, wherein the spacers shaped like a pin are disposed in the apertures for injecting the electrolyte.

6. The method of claim 1, wherein the first substrate and the second substrate are coaxially or biaxially bent.

7. The method of claim 1, wherein the number of curvatures is one or more.

8. The method of claim 1, wherein a radius of the curvature is from about 2 to about 9 m.

9. The method of claim 1, wherein the zig vacuum is configured to adsorb and support the substrate.

10. The method of claim 3, wherein the edge of the zig has a ring-shaped structure holding the substrate to prevent the first substrate or the second substrate from being plane.

11. The method of claim 3, wherein the spacers made of an elastic material are coated on the edge of the zig.

12. The method of claim 5, wherein a diameter of the pin-shaped spacer is about 2 mm or less.

13. The method of claim 5, wherein a material of the pin-shaped spacer is selected from the group consisting of silicon, rubber, resin and Teflon.

14. The method of claim 3, wherein the spacers are U shaped having one open end.

15. The method of claim 1, wherein the outer bonding agent is photocurable or thermosetting epoxy or silicon adhesive.

16. The method of claim 1, wherein a magnitude of stress applied to the curved dye sensitized solar cell module is of about a magnitude of stress applied when one sheet of the thin film glass substrate is curved.

17. A vehicle roof panel comprising a dye sensitized solar cell obtained from a method of claim 1.

18. A vehicle comprising a vehicle roof panel of claim 17.
